(19) United States
(12) Patent Application Publication
(10) Pub. No.: US 2014/0091687 A1
(43) Pub. Date: Apr. 3, 2014

(54) IMAGE READING APPARATUS AND FEEDING APPARATUS

(71) Applicant: Yoshikazu KAWAUCHI, Nagoya-shi, (JP)

(72) Inventor: Yoshikazu KAWAUCHI, Nagoya-shi, (JP)

(21) Appl. No.: 13/851,740

(22) Filed: Mar. 27, 2013

(30) Foreign Application Priority Data
Sep. 28, 2012 (JP) 2012-216760

(51) Int. Cl. H04N 1/04

(52) U.S. Cl. CPC H04N 1/04
USPC 312/223.1

(57) ABSTRACT

An image reading apparatus includes a reader and a casing. The casing includes a first casing, a second casing, a first port and a second port disposed between the first casing and the second casing at a first side of the casing. A width of the second port is less than a width of the first port and the second port overlaps with a portion of the first port. A pivotable member is pivotably attached to the first casing. The pivotable member includes a first arm and a second arm that pivot about a pivoting axis and a connection portion connecting the first arm and the second arm. A wall of the first casing at the first side covers the connection portion.

### CROSS-REFERENCE TO RELATED APPLICATION

This application claims priority from Japanese Patent Application No. 2012-216760 filed on Sep. 28, 2012, the content of which is incorporated herein by reference in its entirety.

### BACKGROUND OF THE INVENTION

1. Field of the Invention

The disclosure relates to an image reading apparatus and a feeding apparatus.

2. Description of Related Art

A known image reading apparatus has an introduction port disposed on a rear side of a casing to introduce a sheet therethrough, and a discharge port disposed on a front side of the casing to discharge the sheet therethrough. A feeding path from the introduction port to the discharge port is disposed in an interior of the casing. An image reading unit is disposed in the feeding path. A feeding roller pair is disposed on an introduction port side and a discharge port side of the image reading unit.

A sheet introduced from the introduction port is fed by the feeding roller pairs in the feeding path. While the sheet is being fed, the image reading unit reads an image on the sheet.

The known image reading apparatus reads an image on a card whose width is less than that of a sheet. More specifically, a portion of the discharge port serves as a card introduction port through which a card is introduced and a card discharge port through which the card is discharged. A mechanism is provided to rotate the feeding roller pairs selectively in one direction and an opposite direction to the one direction.

When a leading end portion of a card is inserted through the card introduction port, the feeding roller pairs are rotated in a direction opposite to a feeding direction of the sheets, to draw the card into the card introduction port with the feeding roller pair. When the card passes the image reading unit, the rotation direction of the feeding roller pairs is reversed, so that the feeding roller pairs are rotated in the same direction as that for feeding the sheets. Thus, the feeding of the card is reversed to feed the card toward the card discharge port. While the card is being fed, the image reading unit reads an image on the card.

A portion of the discharge port configured to discharge the sheets serves as the card introduction port. The sheets are wider than the cards and the discharge port has a width wider than the card introduction port. Therefore, a card may be inserted into the card introduction port in an orientation in which a longer side of a card becomes a leading side (hereinafter, referred to as the “lateral orientation”). When a card is inserted into the card introduction port in the lateral orientation, feeding problems, such as jams, may occur while the card is being fed.

### SUMMARY OF THE INVENTION

The disclosure relate to an image reading apparatus and a feeding apparatus that may prevent a second medium, whose width is shorter than that of a first medium, to be inserted into a second introduction port in a wrong orientation.

According to an embodiment of the invention, an image reading apparatus comprising: a reader, a casing, and a pivotable member. The casing comprises: a first casing; a second casing; a first port disposed between the first casing and the second casing at a first side of the casing; and a second port disposed between the first casing and the second casing at the first side, wherein a width of the second port is less than a width of the first port and the second port overlaps with a portion of the first port. The pivotable member is pivotably attached to the first casing and comprising: a first arm configured to pivot about a pivoting axis; a second arm configured to pivot about the pivoting axis; and a connection portion connecting the first arm and the second arm, such that the first and the second arms pivot together between a first position, in which ends of the first and the second arms cover portions of the first port, and a second position, in which the ends of the first and the second arms are separated from the first port. A wall of the first casing at the first side covers the connection portion.

According to another embodiment of the invention, an image reading apparatus comprising: a reader and a casing. The casing comprising: a first casing; a second casing; a first port disposed between the first casing and the second casing at a first side of the casing; a second port disposed between the first casing and the second casing at the first side, wherein a width of the second port is less than a width of the first port and the second port overlaps with a portion of the first port, a first groove formed in a first surface of the first casing at the first side; a second groove formed in a second surface of the second casing at the first side; a pivotable member pivotably attached to the first casing in the first groove and configured to pivot about a pivoting axis between a first position, in which an end of the pivotable member is disposed in the second groove, and a second position in which the end of the pivotable member is separated from the second groove. A width of the pivotable member in a first direction parallel to the pivoting axis is greater than a width of a gap formed between the end of the pivotable member and a side wall of the second groove in the first direction when the pivotable member is in the second position.

Other objects, features, and advantages will be apparent to persons of ordinary skill in the art from the following detailed description of the disclosure and the accompanying drawings.

### BRIEF DESCRIPTION OF THE DRAWINGS

For a more complete understanding of the disclosure, needs satisfied thereby, and the objects, features, and advantages thereof, reference now is made to the following descriptions taken in connection with the accompanying drawing.

FIG. 1A is a left, front perspective view of an image reading apparatus in which a cover is closed according to an embodiment of the invention.

FIG. 1B is a right, rear perspective view of an image reading in which a cover is closed according to an embodiment of the invention.

FIG. 2 is a right, front perspective view of an image reading apparatus in which a cover is opened according to an embodiment of the invention.

FIG. 3 is a plan view of an image reading apparatus in which a cover is open and an upper casing of the image reading apparatus is in a maintenance position according to an embodiment of the invention.

FIG. 4 is a cross-sectional view of an image reading apparatus according to an embodiment of the invention.

FIG. 5 is a schematic illustrating a sheet discharge port of an image reading apparatus overlaps with a portion of a card introduction port of the image reading apparatus according to an embodiment of the invention.

### DETAILED DESCRIPTION OF EMBODIMENTS OF THE INVENTION

Example embodiments are described in detail herein with reference to the accompanying drawings, like reference numerals being used for like corresponding parts in the various drawings.

An image reading apparatus 1 may be an example of an image reading apparatus and a feeding apparatus of the disclosure. A side of the image reading apparatus 1 on which a front cover 22 is disposed may be defined as a front side of the image reading apparatus 1. A side of the image reading apparatus 1 that is placed on the left when viewed from the front side of the image reading apparatus 1 may be defined as a left side of the image reading apparatus 1. A front-rear direction may be a first direction, a right-left direction may be a second direction, and a top-bottom direction, e.g., a vertical direction, may be a third direction.

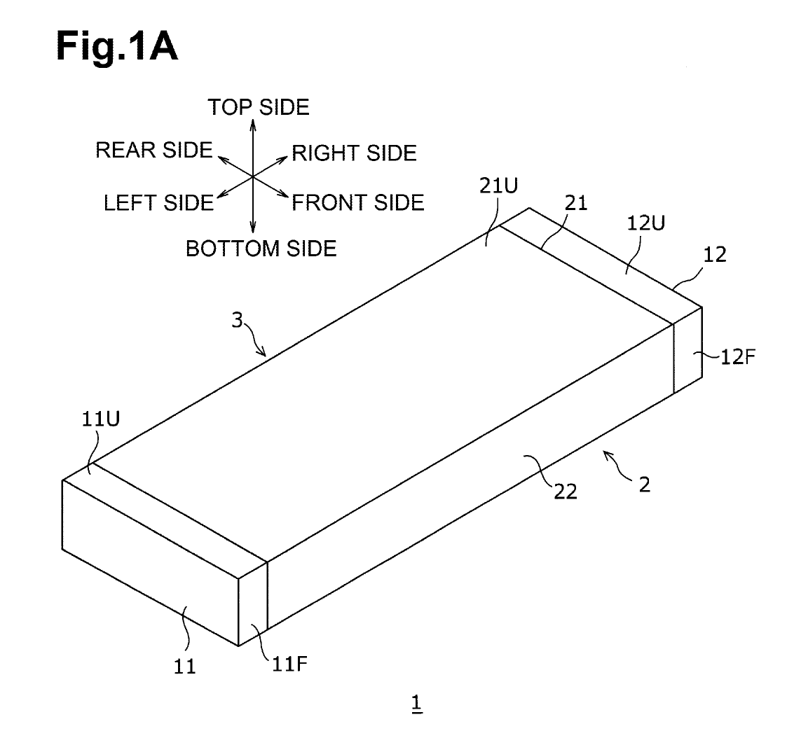

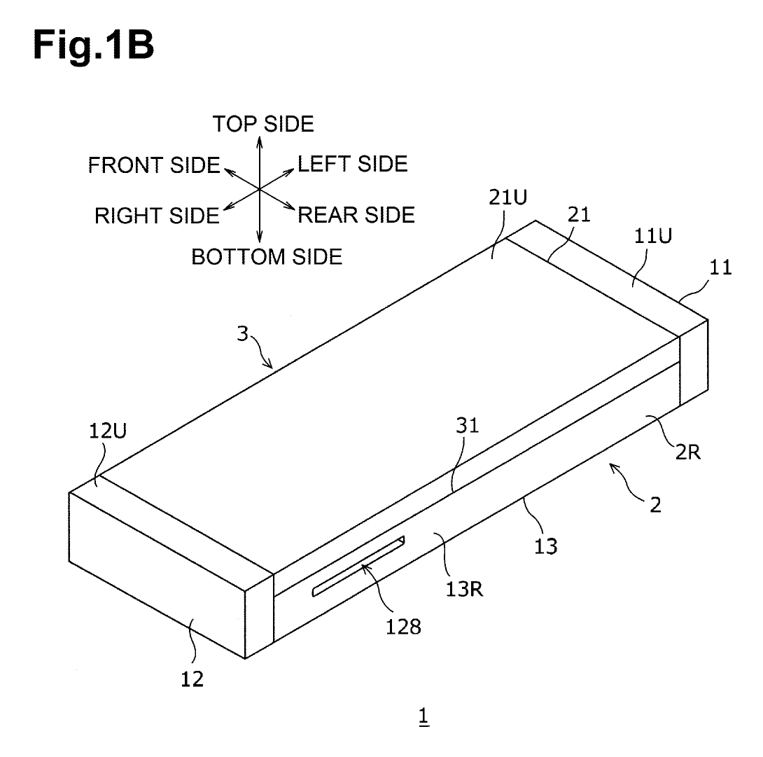

Referring to FIGS. 1A and 1B, the image reading apparatus 1 may comprise a casing 2 and a cover 3. The casing 2 may comprise a left side-plate portion 11, a right side-plate portion 12, a lower casing 13 and an upper casing 14, e.g., a first and a second casings. The left side-plate portion 11 and the right side-plate portion 12 may be disposed with a space therebetween in the right-left direction. The lower casing 13 and the upper casing 14 may be disposed between the left side-plate portion 11 and the right side-plate portion 12. The lower casing 13 may be fixed to the left and right side-plate portions 11 and 12.

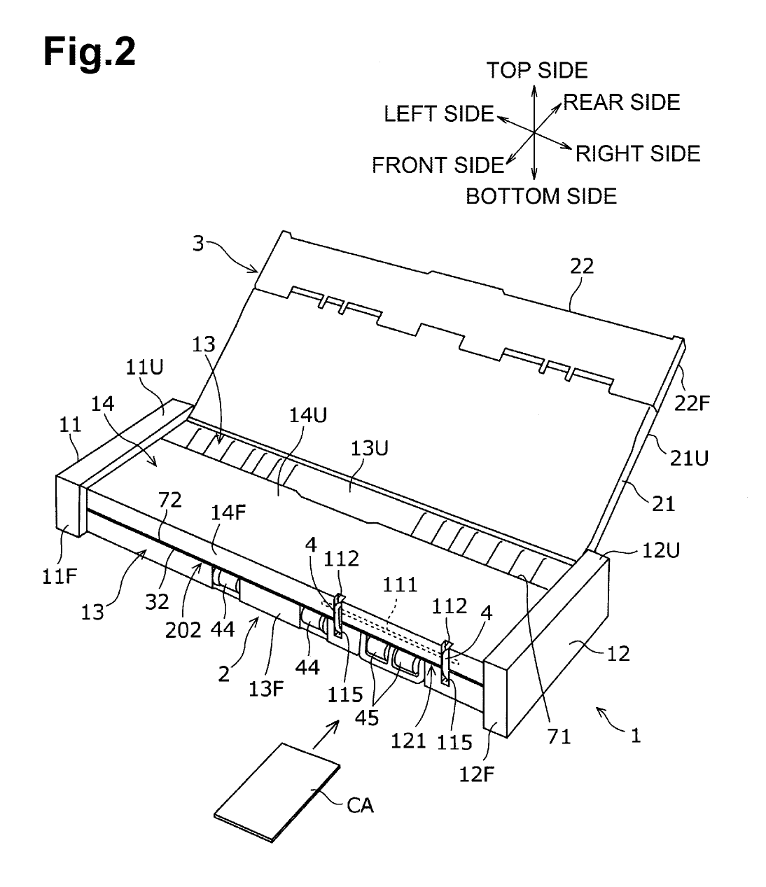

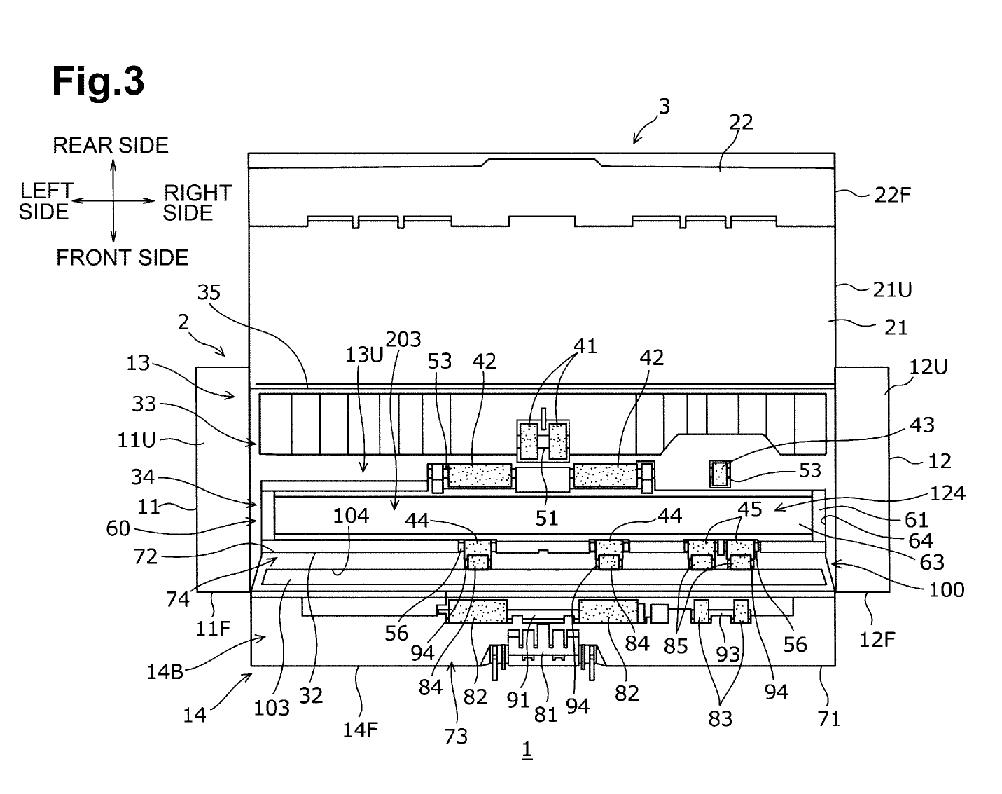

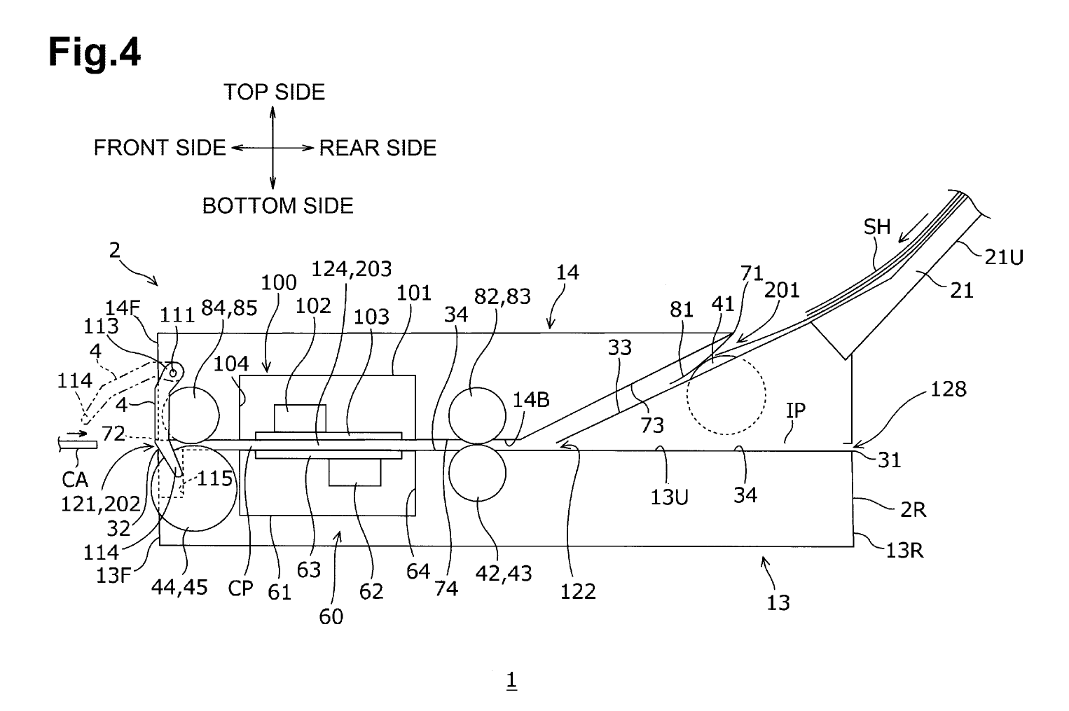

Each of the front lower left and right ends of the upper casing 14 may be provided with a shaft extending leftward and rightward, respectively. The left and right shafts may be rotatably supported by the left and right side-plate portions 11 and 12, respectively. The upper casing 14 may be configured to pivotally move to a normal position, as depicted in FIGS. 2 and 4 and a maintenance position, as depicted in FIG. 3.

Referring to FIG. 2, the upper casing 14 may rest on the lower casing 13 when the upper casing 14 is in the normal position. An upper face 14U of the upper casing 14 placed in the normal position may be positioned lower than upper surfaces 11U and 12U of the left and right side-plate portions 11 and 12, respectively. A front face 14F of the upper casing 14 placed in the normal position may be positioned more rearward than front faces 11F and 12F of the left and right side-plate portions 11 and 12, respectively.

When the upper casing 14 is in the maintenance position, as depicted in FIG. 3, the upper casing 14 may open and extend upward and frontward from a front end of the lower casing with respect to the lower casing 13.

The cover 3 may comprise an upper cover 21 and a front cover 22. A base end portion of the upper cover 21 may be pivotally supported at upper rear ends of the left and right side-plate portions 11 and 12 of the casing 2. The upper cover 21 may be configured to pivotally move to a closed position, as depicted in FIGS. 1A and 1B, and an open position, as depicted in FIG. 2.

When the upper cover 21 is in the closed position, the upper cover 21 may rest on the lower casing 13 and the upper casing 14. When the upper cover 21 is in the open position, the upper cover 21 may extend upward and rearward from an upper rear end of the lower casing 13 of the casing 2. The front cover 22 may be configured to pivotally move between a bending position, as depicted in FIG. 1A, and an extended position, as depicted in FIG. 2.

When the front cover 22 is in the extended position, the front cover 22 may extend substantially on the same plane as that of the upper cover 21 that is placed in the open position. When the upper cover 21 is in the open position and the front cover 22 is in the extended position, the upper cover 21 and the front cover 22 may extend upward and rearward from an upper rear end of the casing 2, as depicted in FIG. 2, and may function as a tray from which a first medium, e.g., sheets SH, may be fed into the casing 2.

A rear end 31 of the lower casing 13 may be positioned higher than a front end 32 of an upper face 13U of the lower casing 13. As depicted in FIG. 4, the lower casing 13 may comprise a slope portion 33 and a flat portion 34. The slope portion 33 may extend forwardly and downwardly from a rear end 35 to the flat portion 34 that may have substantially the same height as the front end 32. The flat portion 34 may extend from the slope portion 33 to the front end 32 at substantially the same height as the front end 32.

A rear end 71 of a lower face 14B of the upper casing 14 may be positioned above the slope portion 33 of the lower casing 13 with a space therebetween, as depicted in FIG. 2, when the upper casing 14 is in the normal position. A front end 72 of the lower face 14B may be positioned above the front end 32 of an upper face 13U of the lower casing 13 with a space therebetween. As depicted in FIGS. 3 and 4, the upper casing 14 may comprise a slope portion 73 and a flat portion 74. The slope portion 73 may extend forwardly and downwardly from the rear end 71 to the flat portion 74 that may have the same height as the front end 72, parallel to the slope portion 33. The flat portion 74 may extend from the slope portion 73 to the front end 72 at the same height as the front end 72 and parallel to the flat portion 34 of the lower casing 13.

A sheet introduction port 201, e.g., first port, a sheet discharge port 202, and a sheet feeding path 203 may be disposed between the upper casing 14 and the lower casing 13. The sheet introduction port 201 may be an example of a first introduction port. The sheet discharge port 202 may be an example of a first discharge port. The sheet feeding path 203 may be an example of a first feeding path. The sheet introduction port 201 may be disposed between the rear end 71 of the upper casing 14 and the slope portion 33 of the lower casing 13. The sheet introduction port 201 may have an open end facing rearward and upward. The sheet discharge port 202 may be disposed between the front end 72 of the upper casing 14 and the front end 32 of the lower casing 13. The sheet discharge port 202 may have an open end facing frontward. The sheet feeding path 203 may connect the sheet introduction port 201 and the sheet discharge port 202. The sheet feeding path 203 may include a space formed between the slope portion 73 of the upper casing 14 and the slope portion 33 of the lower casing 13, and a space formed between the flat portion 74 of the upper casing 14 and the flat portion 34 of the lower casing 13.

The sheet SH introduced from the sheet introduction port 201 may pass through the sheet feeding path 203 in the casing 2 and be discharged from the sheet discharge port 202.

The image reading apparatus 1 may comprise a supply roller 41, a separation pad 81, a line feed (LF) roller 42, a LF pinch roller 82, a card LF roller 43, a card LF pinch roller 83, a first reading unit 100, a second reading unit 60, a discharge roller 44, a discharge pinch roller 84, a card discharge roller 45 and a card discharge pinch roller 85. First reading unit 100 or second reading unit 60 may correspond to a reader.

As depicted in FIG. 3, the supply roller 41 may comprise two roller portions. The two roller portions of the supply roller 41 may be mounted to a rotation shaft 5. The supply roller 41 may be disposed in a central portion of the slope portion 33 in the right-left direction. The rotation shaft 51 may be disposed in the lower casing 13 to extend in the right-left direction. The rotation shaft 51 may be rotatably supported by the lower casing 13.

The separation pad 81 may comprise an elastic material, e.g., rubber. A base end portion of the separation pad 81 may be attached to the upper casing 14. The separation pad 81 may be configured to elastically contact a peripheral surface of the supply roller 41 when the upper casing 14 is in the normal position. The separation pad 81 may be configured to separate the sheets SH one by one together with the supply roller 41, to feed one sheet SH at a time frontward in a sheet feeding direction. The front side of the image reading apparatus 1 may be a downstream side in the sheet feeding direction and the rear side of the image reading apparatus 1 may be an upstream side in the sheet feeding direction.

The LF roller 42 and the LF pinch roller 82 may be disposed in the lower casing 13 and the upper casing 14, respectively, downstream of the supply roller 41 and the separation pad 81 in the sheet feeding direction. As depicted in FIG. 3, the LF roller 42 may comprise two roller portions. The two roller portions of the LF roller 42 may be mounted to a rotation shaft 53. The LF pinch roller 82 may comprise two pinch roller portions. The two pinch roller portions of the LF pinch roller 82 may be mounted to a rotation shaft 91. As depicted in FIG. 4, a peripheral surface of the LF pinch roller 82 may contact a peripheral surface of the LF roller 42 from above when the upper casing 14 is in the normal position. As the LF roller 42 is driven and rotated, the LF pinch roller 82 may rotate in association with the rotation of the LF roller 42.

The card LF roller 43 may be disposed in the lower casing 13 on the right side of the LF roller 42 with a space therebetween. The card LF roller 43 may be mounted to the same rotation shaft 53 as the LF roller 42. The card LF pinch roller 83 may be disposed on the right side of the LF pinch roller 82 with a space therebetween. As depicted in FIG. 3, the card LF pinch roller 83 may comprise two pinch roller portions. The two pinch roller portions of the card LF pinch roller 83 may be mounted to a rotation shaft 93. A peripheral surface of one of the two pinch roller portions of the card LF pinch roller 83 may be disposed on the right and left sides of a peripheral surface of the card LF roller 43 with a space therebetween when the upper casing 14 is in the normal position.

As depicted in FIG. 4, the image reading apparatus 1 may comprise the first reading unit 100 and the second reading unit 60 that may be disposed downstream of the LF roller 42 and LF pinch roller 82 in the sheet feeding direction. The first reading unit 100 may comprise a contact image sensor (CIS) holder 101, a reader, e.g., a CIS unit 102, and a contact glass 103. The second reading unit 60 may comprise a CIS holder 61, a reader, e.g., a CIS unit 62, and a contact glass 63.

The CIS unit 62 may be accommodated in the CIS holder 61. The CIS unit 62 may comprise, for example, a light-emitting diode (LED) light source, a lens, and an image sensor. The CIS unit 102 may be accommodated in the CIS holder 101. The CIS unit 102 may comprise, for example, a LED light source, a lens and an image sensor.

The contact glass 63 may comprise a colorless and transparent glass. The contact glass 63 may be supported by the CIS holder 61 to cover an upper surface thereof. The contact glass 103 may comprise a colorless and transparent glass. The contact glass 103 may be supported by the CIS holder 101 to cover a lower surface thereof.

The CIS holder 61 holding the CIS unit 62 and the contact glass 63 may be fitted in a recess 64 disposed in the flat portion 34 of the lower casing 13. The CIS holder 101 holding the CIS unit 102 and the contact glass 103 may be fitted in a recess 104 disposed in the flat portion 74 of the upper casing 14. Each of the first reading unit 100 and the second reading unit 60 may be configured to read an image on a different side of the sheet SH fed by the LF roller 42 and LF pinch roller 82.

The discharge roller 44 and the discharge pinch roller 84 may be disposed downstream from the CIS unit 102 and the CIS unit 62 in the sheet feeding direction. As depicted in FIG. 3, the discharge roller 44 may comprise two roller portions. The two roller portions of the discharge roller 44 may be mounted to a rotation shaft 56. The discharge pinch roller 84 may comprise two pinch roller portions. The two pinch roller portions of the discharge pinch roller 84 may be mounted to a rotation shaft 94. As depicted in FIG. 4, a peripheral surface of the discharge pinch roller 84 may contact a peripheral surface of the discharge roller 44 from above when the upper casing 14 is in the normal position. As the discharge roller 44 is driven and rotated, the discharge pinch roller 84 may rotate in association with the rotation of the discharge roller 44.

The card discharge roller 45 and the card discharge pinch roller 85 may be disposed downstream from the second reading unit 60 and the first reading unit 100, respectively, in the sheet feeding direction. As depicted in FIG. 3, the card discharge roller 45 may comprise two roller portions. The two roller portions of the card discharge roller 45 may be mounted to the rotation shaft 56. The card discharge pinch roller 85 may comprise two pinch roller portions. The two pinch roller portions of the card discharge pinch roller 85 may be mounted to the rotation shaft 94. As depicted in FIG. 4, a peripheral surface of the card discharge pinch roller 85 may contact a peripheral surface of the card discharge roller 45 from above, when the upper casing 14 is in the normal position. As the card discharge roller 45 is driven and rotated, the card discharge pinch roller 85 may rotate in association with the rotation of the card discharge roller 45.

As depicted in FIGS. 2 and 4, the image reading apparatus 1 may comprises a pair of pivotable members 4, e.g., a first and a second arms. The pivotable members 4 may be disposed at a right front end of the upper casing 14 with a space disposed between the pair of pivotable members in the right-left direction. Distance between the pivotable members 4 may be longer than the width (53.98 mm) of an ID-1 format card whose size is specified by International Organization for Standardization (ISO)/International Electrotechnical Commission (IEC), and shorter than the length (85.60 mm) of the card. The left rotation member 4 may be disposed on the left side of the card discharge pinch roller 85 and the card discharge roller 45. The right rotation member 4 may be disposed on the right side of the card discharge pinch roller 85 and the card discharge roller 45.

The pivotable members 4 may be connected by a rotation shaft 111, e.g., a connection portion. The rotation shaft 111 may be provided for the upper casing 14 inside the upper casing 14. The rotation shaft 111 may extend in the right-left direction, and may be rotatably supported by the upper casing 14. The rotation shaft 111 may extend through two upper groove portions 112, e.g., first groove, in the right-left direction. The upper groove portions 112 may be disposed with a distance therebetween in the right-left direction on the front face 14F of the upper casing 14. Each upper groove portion 112 may have an opening end on the front face 14F and the lower face 14B of the upper casing 14. A base end portion 113 of each rotation member 4 may be attached to the rotation shaft 111 inside the respective upper groove portion 112.

Groove portions, e.g., lower groove portions 115, may comprise a pair of grooves, e.g., second groove, that may be disposed in the lower casing 13 with a space between the pair of grooves in the right-left direction. The lower groove portions 115 may be disposed on the front face 13F of the lower casing 13.

Referring to FIGS. 2 and 4, each rotation member 4 may extend in a vertical direction perpendicular to the rotation shaft 111. Each rotation member 4 may extend from the rotation shaft 111 in a forward and downward direction, then a downward direction, and then in a rearward and downward direction to an end portion 114, as depicted in a solid line in FIG. 4. The end portion 114 of each the rotation member 4 may fit in a respective lower groove portion 115, disposed on the front face 13F of the lower casing 13. Each lower groove portion 115 may be recessed rearward from the front face 13F of the lower casing 13 and recessed downward from the upper face 13U of the lower casing 13. Each lower groove portion 115 may have an open end on the upper face 13U and the front face 13F of the lower casing 13. The pivotable members 4 may pivotally move about the rotation shaft 111 to a closed position in which each end portion 114 are fitted in the respective lower groove portion 115 and to an open position in which each end portion 114 comes forward out of the lower groove portions 115.

When an image on the sheet SH is read in the image reading apparatus 1, the upper cover 21 may be placed in the open position and the front cover 22 may be placed in the extended position as depicted in FIG. 2, to function as the tray. The sheets SH may be placed on the tray that may be defined by the upper cover 21 placed in the open position and the front cover 22 placed in the extended position.

As the sheets SH are placed on the tray, at least one sheet SH may slide on the tray into the sheet introduction port 201 such that a leading end portion of the sheet SH contacts the supply roller 41 and the separation pad 81.

Thereafter, the supply roller 41 may be rotated counterclockwise when viewed from its right side. With the rotation of the supply roller 41, feeding force may be applied by the peripheral surface of the supply roller 41 to the underside of the sheet SH. As the leading end portions of the sheets SH are held between the supply roller 41 and the separation pad 81, the sheets SH may be separated one by one. One sheet SH may pass between the supply roller 41 and the separation pad 81 and be fed toward the LF rollers 42 and 82.

The LF roller 42 and the card LF roller 43 may be rotated counterclockwise when viewed from their right sides. The LF pinch roller 82 and the card LF pinch roller 83 may be rotated clockwise when viewed from their right sides. As the leading end portion of the sheet SH passing between the supply roller 41 and the separation pad 81 reaches the LF roller 42 and the card LF roller 43, feeding force may be applied by the LF roller 42 and the card LF roller 43 to the sheet SH.

The sheet SH passing between the LF roller 42 and LF pinch roller 82 and between the card LF roller 43 and the card LF pinch roller 83 may pass the contact glasses 63, 103. At this time, light may be emitted from the LED light sources of the CIS units 62 and 102 to the sheet SH. The image sensors of the CIS units 62 and 102 may receive the light reflected on the sheet SH. Thus, an image on each side of the sheet SH may be read.

The discharge roller 44 and the card discharge roller 45 may be rotated counterclockwise when viewed from their right sides. The discharge pinch roller 84 and the card discharge pinch roller 85 may be rotated clockwise when viewed from their right sides. As the leading end portion of the sheet SH passing the contact glasses 63 and 103 reaches the discharge roller 44 and the card discharge roller 45, feeding force may be applied by the discharge roller 44 and the card discharge roller 45 to the sheet SH.

The sheet SH passing between the discharge roller 44 and the discharge pinch roller 84 and between the card discharge roller 45 and the card discharge pinch roller 85 may be discharged outside the casing 2 through the sheet discharge port 202. The pivotable members 4 may be placed in the closed position and extend across the sheet discharge port 202 in the vertical direction before the sheet SH is discharged through the sheet discharge port 202. The pivotable members 4 may be raised from its rear side by the leading end of the sheet SH, which is being discharged through the sheet discharge port 202. Thus, the pivotable members 4 may move from the closed position to the open position. The pivotable members 4 may be raised to the open position until the discharge of the sheet SH is completed. As the pivotable members 4 is raised, the end portion 114 of each pivotable member 4 may protrude or stick out forwardly from the respective lower groove portion 115, as depicted by an imaginary line in FIG. 4. When the sheet SH is discharged outside the casing 2 through the sheet discharge port 202, the pivotable members 4 may return to the closed position by their own weight. As the pivotable members 4 return to the closed position, the end portion 114 of each pivotable member 4 may fit in the respective lower groove portion 115, as depicted in a solid line in FIG. 4.

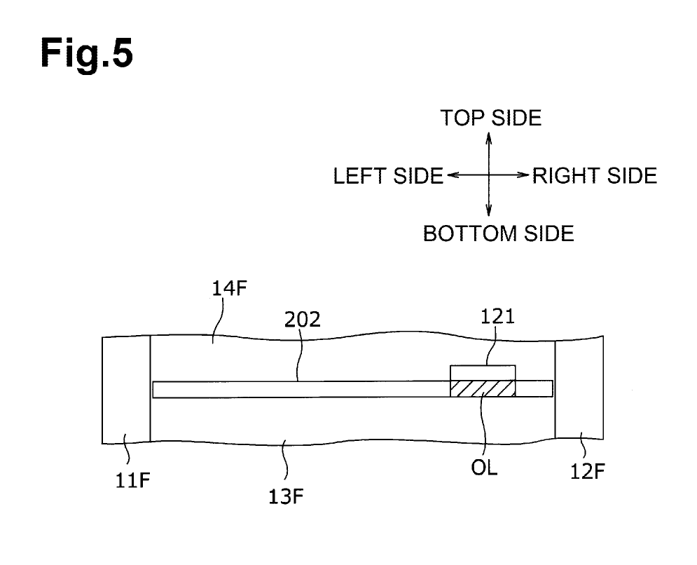

The image reading apparatus 1 may be configured to read an image on a second medium, e.g., a card CA whose width is shorter than that of the sheet SH. As depicted in FIG. 2, a card introduction port 121, e.g., a second port, and a second discharge port, may be disposed between the pivotable members 4 to read an image on the card CA. The card introduction port 121 may overlap a portion of the sheet discharge port 202. For example, a lower portion of the card introduction port 121 may overlap with a right portion of the sheet discharge port 202, as depicted in FIGS. 2 and 5. The sheet SH and the card CA may pass an overlap portion OL, as depicted in FIG. 5. A portion of the front face 14F of the upper casing 14 may be recessed upward, so that the card introduction port 121 may have a height or space in the vertical direction slightly greater than that of the sheet discharge port 202. The pivotable members 4 may extend across the card introduction port 121 in the vertical direction when the pivotable members 4 are in the closed position.

A second feeding path, e.g., a card feeding path 124, may be disposed between the flat portion 34 of the lower casing 13 and the flat portion 74 of the upper casing 14 and below the slope portion 33 of the lower casing 13. The card feeding path 124 may comprise a common path CP that may be a space between the flat portion 34 and the flat portion 74 and an independent path IP that may be a space below the slope portion 33. The independent path IP may be disposed between the slope portion 33 and the flat portion 34. The common path CP may overlap with a right portion of the sheet feeding path 203. Therefore, the card CA and the sheet SH may pass through the common path CP. The independent path IP may be configured to feed the card CA therethrough.

As depicted in FIG. 4, a card passing opening 122 may be disposed between a front lower end of the slope portion 33 and the flat portion 34. The card passing opening 122 may connect the common path CP and the independent path IP. Therefore, the card CA may traverse between the common path CP and the independent path IP, via the card passing opening 122.

When an image on the card CA is read, the card CA may be inserted, with its shorter side being a leading side, into the card introduction port 121 between the pivotable members 4 placed in the closed position.

As a leading end portion of the card CA is inserted into the card introduction port 121, the card discharge roller 45 may be rotated clockwise when viewed from its right side. The card discharge pinch roller 85 may be rotated counterclockwise when viewed from its right side, in association with the rotation of the card discharge roller 45. Feeding force may be applied by the card discharge roller 45 to the card CA. Thus, the card CA may be drawn between the peripheral surface of the card discharge roller 45 and the peripheral surface of the card discharge pinch roller 85.

Thereafter, the card CA may pass between the first reading unit 100 and the second reading unit 60.

The card LF roller 43 may be rotated clockwise when viewed from its right side. The card LF pinch roller 83 may be rotated counterclockwise when viewed from the right side, in association with the rotation of the card LF roller 43. As the leading end portion of the card CA passing between the first reading unit 100 and the second reading unit 60 reaches the card LF roller 43 and the card LF pinch roller 83, feeding force may be applied by the card LF roller 43 to the card CA. Thus, the card CA may be held between the peripheral surface of the card LF roller 43 and the peripheral surface of the card LF pinch roller 83.

As the card CA is fed through the card passing opening 122 to a position where a trailing end of the card CA opposite to the leading end is held between the peripheral surface of the card LF roller 43 and the peripheral surface of the card LF pinch roller 83, rotation of the card LF roller 43 and the card discharge roller 45 may be stopped. As the card LF roller 43 and the card discharge roller 45 stop rotating, feeding of the card CA may be temporarily stopped while a portion of the card CA is discharged from a slot 128.

Thereafter, the card LF roller 43 and the card discharge roller 45 may be rotated counterclockwise when viewed from their right sides. The card LF pinch roller 83 and the card discharge pinch roller 85 may be rotated clockwise when viewed from their right sides. Thus, the feeding direction of the card CA may be reversed and the card CA may be fed in a direction from the rear side to the front side of the image reading apparatus 1.

The card CA may pass between the first reading unit 100 and the second reading unit 60. At this time, light may be emitted from the LED light sources of the CIS units 62, 102 to the card CA. The image sensors of the CIS units 62, 102 may receive the light reflected on the card CA. Thus, an image on each side of the card CA may be read.

As the leading end portion of the card CA passing between the first reading unit 100 and the second reading unit 60 reaches the card discharge roller 45 and the card discharge pinch roller 85, feeding force may be applied by the card discharge roller 45 to the card CA. Thus, the card CA may be held between the peripheral surface of the card discharge roller 45 and the peripheral surface of the card discharge pinch roller 85. The card CA passing between the card discharge roller 45 and the card discharge pinch roller 85 may be discharged outside the casing 2 through the card introduction port 121. The card CA introduced from the card introduction port 121 may be fed and discharged from the card introduction port 121 between the pivotable members 4.

When the sheet SH is discharged from the sheet discharge port 202, the leading end of the sheet SH may push the pivotable members 4 to raise the end portions 114 of the pivotable members 4. Therefore, the sheet discharge port 202 may open. Thus, the pivotable members 4 may not prevent the smooth feeding of the sheet SH may be reduced, and the sheet SH may be smoothly discharged.

When the pivotable members 4 are in the closed position, the end portions 114 of the pivotable members 4 may fit in the lower groove portions 115. Therefore, the end portions 114 of the pivotable members 4 may not be touched by users' fingers. Therefore, the users may not raise the end portions 114 of the pivotable members 4. Consequently, insertion of the card CA into the card introduction port 121 in the lateral orientation, in which the longer side of the card CA is the leading side, may be reduced or prevented.

When the pivotable members 4 are in the closed position, each pivotable member 4 may extend across the card introduction port 121 in the vertical direction. The distance between the pivotable members 4 may be determined based on a length of the shorter side of the card CA, e.g., a width of the card CA. Therefore, when the card CA is to be inserted into the card introduction port 121 in the lateral orientation with the pivotable members 4 in the closed position, the longer side of the card CA may contact the pivotable members 4. Accordingly, such possibilities that the card CA is inserted into the card introduction port 121 in the lateral orientation may be reduced.

The rotation shaft 111 may be disposed inside the upper casing 14. Thus, such possibilities that the rotation shaft 111 is rotated by users' fingers may be reduced or prevented. Consequently, such possibilities that the end portions 114 of the pivotable members 4 are raised may further be reduced or prevented.

The rotation shaft 111 may be disposed in the upper casing 14, so that the pivotable members 4 may be suspended downward due to the gravity. The pivotable members 4 may be normally placed in the closed position. Thus, such possibilities that the pivotable members 4 are placed in the open position may be reduced or prevented.

While the disclosure has been described in detail with reference to the specific embodiment thereof, this is merely an example, and various changes, arrangements and modifications may be applied therein without departing from the spirit and scope of the disclosure.

The lower groove portions 115 may be disposed in the lower casing 13, and the rotation shaft 111 for the pivotable members 4 may be disposed in the upper casing 14. In another embodiment, a rotation shaft for the pivotable members may be disposed in the lower casing 13, and a groove portion in which an end portion of the pivotable member may be disposed in the upper casing 14.

The image reading apparatus 1 may comprise a pair of the pivotable members 4. In another embodiment, the image reading apparatus 1 may comprise one pivotable member 4. Thus, the pivotable member 4 may be disposed such that the distance from the right end of the sheet discharge port 202 may be longer than a width of an ID-1 format card whose size is specified by International Organization for Standardization (ISO)/International Electrotechnical Commission (IEC), and shorter than a length of the card. Thus, the pivotable member 4 is positioned such that the possibilities that the card CA is inserted into the card introduction port 121 in the lateral orientation may be reduced or prevented.

A lower portion of the card introduction port 121 may overlap with a right portion of the sheet discharge port 202, as depicted in FIG. 5. In another embodiment, a whole area of the card introduction port 121 may overlap with a right portion of the sheet discharge port 202. For example, a right portion of the sheet discharge port 202 may overlap with a left portion of the card introduction port 121.

The card introduction port 121 may serve as the card discharge port through which the card CA is discharged. The card CA introduced from the card introduction port 121 may be fed rearward and then forward in the card feeding path 124. Thereafter, the card CA may be discharged from the card introduction port 121. In another embodiment, the card CA introduced from the card introduction port 121 may be fed rearward in the card feeding path 124 and discharged through the slot 128 outside the image reading apparatus 1. The first reading unit 100 and the second reading unit 60 may be configured to read an image on the card CA while the card CA is being fed rearward in the card feeding path 124.

What is claimed is:

1. An image reading apparatus comprising:
a reader;
a casing comprising:
a first casing;
a second casing;
a first port disposed between the first casing and the second casing at a first side of the casing; and
a second port disposed between the first casing and the second casing at the first side, wherein a width of the second port is less than a width of the first port and the second port overlaps with a portion of the first port; and
a pivotable member pivotably attached to the first casing and comprising:
a first arm configured to pivot about a pivoting axis;
a second arm configured to pivot about the pivoting axis; and
a connection portion connecting the first arm and the second arm, such that the first and the second arms pivot together between a first position, in which ends of the first and the second arms cover portions of the first port, and a second position, in which the ends of the first and the second arms are separated from the first port,
wherein a wall of the first casing at the first side covers the connection portion.

2. The image reading apparatus of claim 1, wherein the casing further comprises:
a first groove formed in a first surface of the first casing at the first side; and
a second groove formed in a second surface of the second casing at the first side,
wherein the first arm is pivotably attached in the first groove and the end of the first arm is disposed in the second groove when the pivotable member is in the first position.

3. The image reading apparatus of claim 2, wherein a width of the first groove in a first direction parallel to the pivoting axis is the same as a width of the second groove in the first direction.

4. The image reading apparatus of claim 2, wherein the first surface, in which the first groove is formed, is flush with the second surface, in which the second groove is formed.

5. The image reading apparatus of claim 2,
wherein the second groove is formed between the second surface of the second casing and a third surface of the second casing, and
wherein the second surface is perpendicular to the third surface and forms a right-angled corner with the third surface.

6. The image reading apparatus of claim 2,
wherein the end of the first arm contacts an inner wall that forms the second groove.

7. An image reading apparatus comprising:
a reader;
a casing comprising:
a first casing;
a second casing;
a first port disposed between the first casing and the second casing at a first side of the casing; and
a second port disposed between the first casing and the second casing at the first side, wherein a width of the second port is less than a width of the first port and the second port overlaps with a portion of the first port;
a first groove formed in a first surface of the first casing at the first side;
a second groove formed in a second surface of the second casing at the first side;
a pivotable member pivotably attached to the first casing in the first groove and configured to pivot about a pivoting axis between a first position, in which an end of the pivotable member is disposed in the second groove, and a second position in which the end of the pivotable member is separated from the second groove,
wherein a width of the pivotable member in a first direction parallel to the pivoting axis is greater than a width of a gap formed between the end of the pivotable member and a side wall of the second groove in the first direction when the pivotable member is in the second position.

8. The image reading apparatus of claim 7, wherein a width of the first groove in the first direction is the same as a width of the second groove in the first direction.

9. The image reading apparatus of claim 7, wherein the first surface, in which the first groove is formed, is flush with the second surface, in which the second groove is formed.

10. The image reading apparatus of claim 7,
wherein the second groove is formed between the second surface of the second casing and a third surface of the second casing, and
wherein the second surface is perpendicular to the third surface and forms a right-angled corner with the third surface.

11. The image reading apparatus of claim 7,
wherein the end of the pivotable member contacts an inner wall that forms the second groove when the pivotable member is in the second position.
